(19) United States
(12) Patent Application Publication
(10) Pub. No.: US 2024/0189798 A1
(43) Pub. Date: Jun. 13, 2024

(54) SORBENTS FOR REMOVAL OF NITROGEN OXIDES AND METHOD OF MAKING

(71) Applicant: CALGON CARBON CORPORATION, Moon Township, PA (US)

(72) Inventors: Philippe WESTREICH, Pittsburgh, PA (US); Jason P. MAZZOCCOLI, Pittsburgh, PA (US); Richard A. MIMNA, Oakdale, PA (US)

(73) Assignee: CALGON CARBON CORPORATION, Moon Township, PA (US)

(21) Appl. No.: 18/538,606

(22) Filed: Dec. 13, 2023

Related U.S. Application Data
(60) Provisional application No. 63/387,252, filed on Dec. 13, 2022.

(51) Int. Cl. B01J 20/32; B01D 53/56; B01D 53/81; B01J 20/02; B01J 20/20; B01J 20/22; B01J 20/28

(52) U.S. Cl. CPC B01J 20/3289; B01D 53/565; B01D 53/81; B01J 20/0237; B01J 20/0244; B01J 20/20; B01J 20/22; B01J 20/28011; B01J 20/28016; B01J 20/3204; B01J 20/3236; B01D 2253/102; B01D 2253/25; B01D 2257/404; B01D 2258/06

(57) ABSTRACT

The present disclosure described compositions which may be effective in removing contaminants from a gas stream such as nitrous oxides. The composition may include a sorbent which contains triethylenediamine and a metal including copper, zinc, or a combination thereof. Methods of making such a composition are also described, along with devices which use the composition to remove contaminants from fluid streams, particularly in vehicle tunnels and parking garages.

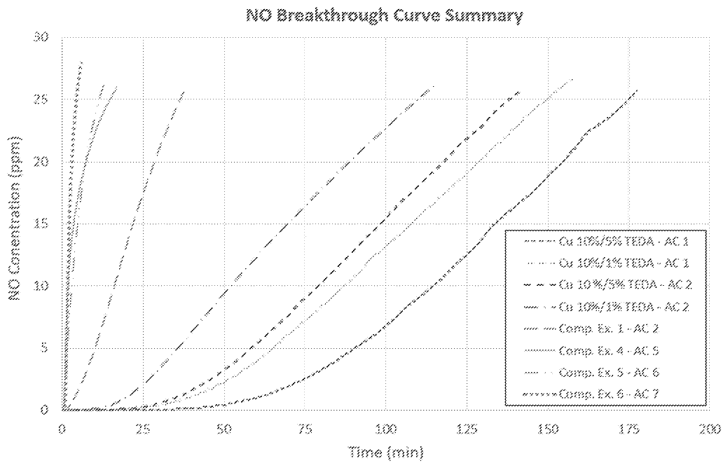

### CROSS-REFERENCE TO RELATED APPLICATIONS

This application claims the benefit of U.S. Provisional Application No. 63/387,252 filed on Dec. 13, 2022, which is hereby incorporated by reference in its entirety.

### BACKGROUND

Sorbents such as activated carbon have long been used to remove toxic gases and vapors from fluid streams. For example, activated carbons that are incorporated into a filter are useful for removing noxious agents from fluids in the gas phase, for example breathing air or exhaust gases. This is common in applications such as gas mask filters, collective filters, and other applications. Activated carbons used to remove noxious agents are often treated with various components that adsorb, catalyze, react, or otherwise interact with noxious gases that would otherwise not be removed by contacting the noxious gases with untreated activated carbons.

In particular, nitrogen dioxide and related nitrogen oxides (NOx) are examples of noxious gases that must be removed from breathing air or exhaust gases. Previous adsorbents have used various carbon-based and non-carbon-based sorbents with high costs and low effectiveness.

Further, the use of triethylenediamine (TEDA) in filters and sorbent media designed to remove military gases from a gas stream has long been recognized. In particular, TEDA is accepted as a critical material in providing protection against cyanogen chloride (CK) gas in chromium-free compositions, which may also contain copper and in some cases zinc. There is a desire to improve nitrogen oxide removal for other air purification applications.

Regulations on vehicle emissions have driven air purification technologies forward, though there remains a need for sorbents and systems that effectively remove harmful components from vehicle exhaust. Particularly in enclosed areas such as vehicle tunnels and parking garages, it is crucial that nitrogen oxides and other contaminants are effectively removed to comply with environmental regulations and ensure safe air quality.

### SUMMARY

In some aspects, the techniques described herein relate to a composition for removing nitrogen oxides from a fluid stream in a vehicle tunnel, including: a sorbent having a first surface deposition including: about 1 wt. % to about 6 wt. % triethylenediamine, and about 3 wt. % to about 15 wt. % of a metal including copper, zinc, or a combination thereof.

In some aspects, the techniques described herein relate to a composition, wherein the metal includes zinc, and the zinc is in the form of zinc oxide, elemental zinc, or combinations thereof.

In some aspects, the techniques described herein relate to a composition, wherein the sorbent includes one or more of activated carbon, natural zeolite, synthetic zeolite, silica, silica gel, alumina, zirconia, diatomaceous earths, metal organic frameworks, or combinations thereof.

In some aspects, the techniques described herein relate to a composition, wherein the sorbent is in the form of pellets, granules, reagglomerated briquettes, powders, or combinations thereof.

In some aspects, the techniques described herein relate to a composition, wherein the composition has not been treated to add molybdenum or silver.

In some aspects, the techniques described herein relate to a composition, wherein the copper is in the form of copper (I) oxide, copper (II) oxide, elemental copper, or combinations thereof.

In some aspects, the techniques described herein relate to a composition, wherein the first surface deposition includes about 5 wt. % to about 10 wt. % copper.

In some aspects, the techniques described herein relate to a composition, wherein the nitrogen oxides are nitrogen dioxide, nitrogen monoxide, or combinations thereof.

In some aspects, the techniques described herein relate to a composition, wherein the composition exhibits a longer breakthrough time than a composition which does not include a sorbent having a first surface deposition including about 1 wt. % to about 6 wt. % triethylenediamine and about 3 wt. % to about 15 wt. % copper.

In some aspects, the techniques described herein relate to a composition, wherein the composition exhibits a breakthrough time of more than about 40 minutes at 25 ppm nitrogen monoxide (NO) as measured by CBRN testing method 0308 with a bed depth of 3.3 cm and a linear velocity of 12.1 cm/s.

In some aspects, the techniques described herein relate to a composition, wherein the composition exhibits a breakthrough time of more than about 100 minutes at 25 ppm nitrogen monoxide (NO) as measured by CBRN testing method 0308 with a bed depth of 3.3 cm and a linear velocity of 12.1 cm/s.

In some aspects, the techniques described herein relate to a method of making a composition for removing nitrogen oxides from a fluid stream in a vehicle tunnel, including: contacting a sorbent material with a first solution including a copper salt, a zinc-containing compound, or a combination thereof to form an impregnated sorbent material, drying the impregnated sorbent material to form a dried impregnated sorbent material, and contacting the dried impregnated sorbent material with triethylenediamine to form a sorbent, wherein the sorbent is not impregnated with either of molybdenum or silver.

In some aspects, the techniques described herein relate to a method, wherein the zinc-containing compound includes zinc oxide.

In some aspects, the techniques described herein relate to a method, wherein the sorbent material includes activated carbon, natural zeolite, synthetic zeolite, silica, silica gel, alumina, zirconia, diatomaceous earths, or combinations thereof.

In some aspects, the techniques described herein relate to a method, wherein the copper salt includes copper carbonate, copper chloride, copper acetate, copper gluconate, copper formate, copper sulfate, copper nitrate, or combinations thereof.

In some aspects, the techniques described herein relate to a method, wherein the first solution further includes ammonia.

In some aspects, the techniques described herein relate to a method, wherein contacting the dried impregnated sorbent material with triethylenediamine includes immersing the dried impregnated sorbent material in a solution of triethylenediamine, spraying a solution of triethylenediamine onto a surface of the dried impregnated sorbent material, mixing dry triethylenediamine with the dried impregnated sorbent material, or combinations thereof.

In some aspects, the techniques described herein relate to a method, wherein the nitrogen oxides are nitrogen dioxide, nitrogen monoxide, or combinations thereof.

In some aspects, the techniques described herein relate to a method of removing nitrogen oxides from a fluid stream within a vehicle tunnel, including: providing a composition including: a sorbent having a first surface deposition including about 1 wt. % to about 6 wt. % triethylenediamine and about 3 wt. % to about 15 wt. % of a metal including copper, zinc, or a combination thereof, directing an initial fluid stream from the vehicle tunnel to an air filter device including the composition, contacting the initial fluid stream with the composition to produce a treated fluid stream, and directing the treated fluid stream back into the vehicle tunnel.

In some aspects, the techniques described herein relate to a method, wherein the sorbent includes activated carbon, natural and synthetic zeolite, silica, silica gel, alumina, zirconia, diatomaceous earths, metal organic frameworks, or combinations thereof.

In some aspects, the techniques described herein relate to a method, wherein the sorbent is in the form of pellets, granules, reagglomerated briquettes, powders, or combinations thereof.

In some aspects, the techniques described herein relate to a method, wherein the copper is in the form of copper (I) oxide, copper (II) oxide, elemental copper, or combinations thereof.

In some aspects, the techniques described herein relate to a method, wherein the first surface deposition includes about 5 wt. % to about 10 wt. % copper.

In some aspects, the techniques described herein relate to a method, wherein the nitrogen oxides are nitrogen dioxide, nitrogen monoxide, or combinations thereof.

In some aspects, the techniques described herein relate to a method, wherein the treated fluid stream contains a lower concentration of nitrogen oxides than the initial fluid stream.

In some aspects, the techniques described herein relate to a tunnel air filter device for removing nitrogen oxides from a fluid stream in a vehicle tunnel, including: a sorbent having a first surface deposition including: about 1 wt. % to about 6 wt. % triethylenediamine, and about 3 wt. % to about 15 wt. % of a metal including copper, zinc, or a combination thereof, wherein the sorbent is contained within a housing.

In some aspects, the techniques described herein relate to a tunnel air filter device, wherein the first surface deposition includes about 5 wt. % to about 10 wt. % zinc.

In some aspects, the techniques described herein relate to a tunnel air filter device, wherein the tunnel air filter device is exposed to about two hundred thousand cubic meters of vehicle exhaust per hour to about ten million cubic meters of vehicle exhaust per hour.

In some aspects, the techniques described herein relate to a tunnel air filter device, wherein the tunnel air filter device is positioned inside or adjacent to a vehicle tunnel.

In some aspects, the techniques described herein relate to a tunnel air filter device, wherein the copper is in the form of copper (I) oxide, copper (II) oxide, elemental copper, or combinations thereof.

In some aspects, the techniques described herein relate to a tunnel air filter device, wherein the first surface deposition includes about 5 wt. % to about 10 wt. % copper.

In some aspects, the techniques described herein relate to a tunnel air filter device, wherein the nitrogen oxides are nitrogen dioxide, nitrogen monoxide, or combinations thereof.

In some aspects, the techniques described herein relate to a tunnel air filter device, wherein the sorbent includes activated carbon, natural zeolite, synthetic zeolite, silica, silica gel, alumina, zirconia, diatomaceous earths, metal organic frameworks, or combinations thereof.

In some aspects, the techniques described herein relate to a tunnel air filter device, wherein the sorbent is in the form of pellets, granules, reagglomerated briquettes, powders, or combinations thereof.

In some aspects, the techniques described herein relate to a tunnel air filter device, wherein the sorbent exhibits a longer breakthrough time than a sorbent which does not have a first surface deposition including about 1 wt. % to about 6 wt. % triethylenediamine and about 3 wt. % to about 15 wt. % copper.

In some aspects, the techniques described herein relate to a tunnel air filter device, wherein the sorbent exhibits a breakthrough time of more than about 40 minutes at 25 ppm nitrogen monoxide (NO) as measured by CBRN testing method 0308 with a bed depth of 3.3 cm and a linear velocity of 12.1 cm/s.

In some aspects, the techniques described herein relate to a tunnel air filter device, wherein the sorbent exhibits a breakthrough time of more than about 100 minutes at 25 ppm nitrogen monoxide (NO) as measured by CBRN testing method 0308 with a bed depth of 3.3 cm and a linear velocity of 12.1 cm/s.

### DRAWINGS

Aspects, features, benefits, and advantages of the embodiments described herein will be apparent with regard to the following description, appended claims, and accompanying drawings where:

The FIGURE depicts a series of nitrogen monoxide breakthrough times for a plurality of sorbent materials.

### DETAILED DESCRIPTION

Before the present compositions and methods are described, it is to be understood that this invention is not limited to the particular processes, compositions, or methodologies described, as these may vary. It is also to be understood that the terminology used in the description is for the purpose of describing the particular versions or embodiments only, and is not intended to limit the scope of the present invention, which will be limited only by the appended claims. Unless defined otherwise, all technical and scientific terms used herein have the same meaning as commonly understood by one of ordinary skill in the art. Although any methods and materials similar or equivalent to those described herein can be used in the practice or testing of embodiments of the present invention, the preferred methods, devices, and materials are now described. All publications mentioned herein are incorporated by reference in their entirety. Nothing herein is to be construed as an admission that the invention is not entitled to antedate such disclosure by virtue of prior invention.

It must also be noted that as used herein and in the appended claims, the singular forms “a,” “an,” and “the” include plural reference unless the context clearly dictates otherwise. Thus, for example, reference to “a combustion chamber” is a reference to “one or more combustion chambers” and equivalents thereof known to those skilled in the art, and so forth.

As used herein, the term “about” means plus or minus 10% of the numerical value of the number with which it is being used. Therefore, about 50% means in the range of 45%-55% and also includes exactly 50%.

As used herein, the term “sorbent material” refers to an adsorbent compound which may serve as a precursor or intermediate to a final sorbent. For example, sorbent materials include, but are not limited to, activated carbon, natural zeolite, synthetic zeolite, silica, silica gel, alumina, zirconia, diatomaceous earths, and metal organic frameworks.

As used herein, the term “sorbent” is meant to encompass a sorbent material which has, in some embodiments, been treated with thermal, chemical, or other means.

As used herein, the term “vehicle tunnel” refers to any substantially enclosed or semi-enclosed area where undesirable gases, such as NOx may be present or accumulate, such as, but not limited to areas through which vehicles travel or are stored. The term “vehicle tunnel” derives from the fact that highway tunnels are well-known to meet these conditions. In some embodiments, a vehicle tunnel is exposed to or contains about two hundred thousand cubic meters of vehicle exhaust per hour to about ten million cubic meters of vehicle exhaust per hour. The term is not to be limited to traditional roadway tunnels but can be applied to any area where such gases can accumulate, for example, but not limited to, roadway tunnels, train tunnels, parking garages, airplane hangars, bus or vehicle depots, mines, warehouses, indoor ice rinks, underground facilities/bases, indoor sporting arenas, factories, etc.

Various embodiments of the invention are directed to sorbents for removal of noxious or toxic gases from air or other gas streams. Other embodiments are directed to methods for producing such sorbents and filter apparatuses including these sorbents.

In some embodiments, there is provided a composition for removing contaminants such as oxides of nitrogen from a fluid stream, wherein the fluid stream may, in some embodiments, be found in a vehicle tunnel. In some embodiments, the fluid stream is a gas stream. The composition can include a first sorbent, which in some embodiments includes a sorbent material. In some embodiments, a sorbent material, such as for example activated carbon, is treated or processed to provide a final sorbent.

Embodiments are not limited to any particular sorbent material. For example, the sorbent material may be any of activated carbon, reactivated carbon, natural and synthetic zeolite, silica, silica gel, alumina, diatomaceous earths, zirconia, and the like and combinations thereof. In some embodiments, the sorbent material may include metal organic frameworks, alone or in combination with others of the above-listed sorbent materials. In certain embodiments, the sorbent material may be an activated carbon or reactivated carbon. In such embodiments, the activated carbon may be obtained from any source and can be made from a variety of starting materials. For example, suitable materials for production of activated carbon include, but are not limited to, coals of various ranks such as anthracite, semi-anthracite, bituminous, sub-bituminous, brown coals, or lignites; nutshells, such as coconut shell; wood; vegetables and plant matter such as rice hull or straw; residues or by-products from petroleum processing; and natural or synthetic polymeric materials. The carbonaceous material may be processed into carbon adsorbents by any conventional thermal or chemical methods known in the art and will inherently impart different surface areas and pore volumes depending on the starting materials and processing used. In particular embodiments, the activated carbon may be a coal based activated carbon, and in some embodiments, the starting material may be bituminous coal.

The sorbents described herein can be used to adsorb or otherwise remove, such as by catalysis, reaction, or other means, various toxic or noxious gases and organic vapors from streams of fluid such as, for example, air. A wide variety of toxic or noxious gases can be removed by these sorbents such as, for example, HCN, CNCl, H₂S, Cl₂, SO₂, NO, NO₂, formaldehyde, and NH₃. In some embodiments, the toxic or noxious gas may be a nitrogen oxide (NOₓ), such as, for example, NO₂, nitrogen dioxide and NO, nitrogen monoxide Similarly, various organic vapors such as, for example, CCl₄, benzene, toluene, acetone, organic solvents, and the like can be adsorbed by the sorbents described herein. Therefore, in some embodiments, the sorbent can be provided in fixed beds through which streams of gas that include or potentially include toxic or noxious contaminant gases are passed. In other embodiments, the sorbent can be contained within a housing that is attached to, for example, respirators, gas masks, compressed breathing air devices, and the like through which gas streams including potentially toxic or noxious contaminates are passed.

The composition described herein can include a sorbent having a first surface deposition. In some embodiments, the first surface deposition includes about 1 wt. % to about 10 wt. % triethylenediamine (TEDA), such as about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, or any range or value contained therein. In some embodiments, the first surface deposition includes about 1 wt. % to about 6 wt. % triethylenediamine (TEDA). It is contemplated that the amount of TEDA may be selected according to the application for which the sorbent is used. For example, in some embodiments, it may be desirable to select an amount of TEDA such that the sorbent is at minimal risk of self-heating to the point of thermal runaway. In some embodiments, it may be desirable to select an amount of TEDA such that the sorbent exhibits a specific performance metric, particularly in terms of the sorbent's ability to remove oxides of nitrogen from a fluid stream.

In some embodiments, the first surface deposition includes about 3 wt. % to about 15 wt. % of a metal which includes copper, zinc, or a combination thereof. In some embodiments, the first surface deposition includes copper, such that the total content of copper species is about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, or any range or value contained therein. In some embodiments, the copper includes elemental copper, copper (II) oxide, copper (I) oxide, or combinations thereof. The weight percentage described herein refers to the weight percent of copper present in the composition, though in some embodiments the copper is in the form of copper oxides, other copper salts (including but not limited to copper salts which may be used in the preparation of the presently disclosed composition such as copper carbonate, copper chloride, copper acetate, copper gluconate, copper formate, copper sulfate, and copper nitrate), elemental copper, or combinations thereof, as described herein. In some embodiments, the first surface deposition includes both about 1 wt. % to about 10 wt. % triethylenediamine and about 3 wt. % to about 15 wt. % copper. In some embodiments, the copper is in the form of copper (I) oxide, copper (II) oxide, copper (I) hydroxide, copper (II) hydroxide, elemental copper, or combinations thereof.

In some embodiments, the first surface deposition includes zinc, such that the total content of zinc species is about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, or any range or value contained therein. The weight percentage described herein refers to the weight percent of zinc present in the composition, though in some embodiments the zinc is in the form of zinc oxides, other zinc salts (including but not limited to zinc salts which may be used in the preparation of the presently disclosed composition such as zinc carbonate, zinc chloride, zinc acetate, zinc gluconate, zinc formate, zinc sulfate, and zinc nitrate). In some embodiments, the zinc may be in the form of elemental zinc, zinc oxide, zinc hydroxide, or a combination thereof.

In some embodiments, the sorbent is in the form of pellets, granules, reagglomerated briquettes, powders, or combinations thereof.

In some embodiments, the composition described herein is substantially free of molybdenum and silver. As used herein, “substantially free of” refers to the fact that the aforementioned compounds have not been added to the composition of the present disclosure, and while the composition may contain trace amounts of these or other compounds, such compounds have not been added to the composition so as to specifically increase their concentration. In some embodiments, the composition described herein has not been treated or impregnated to add either of molybdenum or silver. Avoiding the use of these additives permits the formation of an effective sorbent targeted for NOx removal without the unnecessary cost of additional materials.

In some embodiments, the composition described herein may be evaluated for its efficacy in removing oxides of nitrogen such as nitrogen oxide (NO) or nitrogen dioxide (NO₂) or other contaminants, particularly from a gas stream in a vehicle tunnel. One such method of evaluation is the measurement of breakthrough time, which represents the time after which the composition can no longer absorb or adsorb the contaminant of interest. In some embodiments, NO or NO₂ may be used as a challenge gas. In some embodiments, if NO₂ is used as a challenge gas, both NO₂ and NO may be present, and the breakthrough of both NO₂ and NO may be measured. It is contemplated that the breakthrough of one or the other of NO₂ and NO may be reached first. In some embodiments, the measurement of breakthrough time is concluded when the breakthrough of either NO or NO₂ is reached. In some embodiments, NO₂ is used as the challenge gas and the breakthrough of NO is reached first.

In some embodiments, the composition described herein which has a first surface deposition including about 1 wt. % to about 10 wt. % TEDA and about 3 wt. % to about 15 wt. % of a metal which includes copper, zinc, or a combination thereof exhibits a longer breakthrough time than a composition which does not have a first surface deposition including about 1 wt. % to about 10 wt. % TEDA and about 3 wt. % to about 15 wt. % a metal which includes copper, zinc, or a combination thereof. In some embodiments, the composition is not impregnated with either of molybdenum or silver. The composition described herein may exhibit a breakthrough of more than about 40 minutes at 25 ppm nitrogen monoxide (NO), for example, more than 40 minutes, more than 60 minutes, more than 80 minutes, more than 100 minutes, more than 120 minutes, more than 140 minutes, more than 160 minutes, more than 180 minutes, and so forth. It is contemplated that these breakthrough times are measured using CBRN testing method 0308, which is described herein. Other methods for measuring breakthrough time that are familiar to those of ordinary skill in the art may also be used, though the breakthrough times referred to in the present disclosure are in reference to the specific testing conditions described herein. In some embodiments, the breakthrough times referred to herein are measured using a bed depth of about 3.3 cm and a linear velocity of about 12.1 cm/s. It is contemplated that other breakthrough times may be obtained if other testing conditions are used. It is desirable, in some embodiments, for the composition to exhibit a longer breakthrough time so that the composition may be used for a longer period of time before needing to be replaced.

Certain embodiments are directed to methods for making the composition described above. In some embodiments, the methods may include one or more steps of impregnating a sorbent material with an additive. As described above, the sorbent material may include any of activated carbon, reactivated carbon, natural and synthetic zeolite, silica, silica gel, alumina, diatomaceous earths, zirconia and the like and combinations thereof. The step of impregnating is well known in the art and can be carried out in any number of ways. Typically, impregnating includes the step of contacting a sorbent material, by immersion or other means, with an impregnation solution containing one or more additives that are dissolved or dispersed in the impregnating solution. The impregnating solution may include one or more additives that will become associated with the sorbent material while the sorbent material is in contact with the impregnating solution. Impregnating can be carried out in one or more impregnating steps. For example, in some embodiments, all of the additives incorporated onto the sorbent material may be included in the impregnating solution such that all of the additives can become associated with the sorbent material in a single impregnating step. In other embodiments, the impregnating solution may include a single additive and a separate impregnating step may be necessary for each additive incorporated onto the sorbent material. In still other embodiments, impregnating can be carried out by impregnating with a first impregnating solution including two or more additives and impregnating with a second impregnating solution including one or more additives. In yet other embodiments, impregnating can be carried out using three or more impregnating steps in which each impregnating solution includes one, two, three, four, or more additives. In some embodiments, impregnating the sorbent material with an additive as described herein forms an impregnated sorbent material.

In some embodiments, the method of making a composition for removing nitrogen oxides from a fluid stream in a vehicle tunnel includes steps of contacting a sorbent material with a first solution including a copper salt to form an impregnated sorbent material, drying the impregnated sorbent material to form a dried impregnated sorbent material, and contacting the dried impregnated sorbent material with triethylenediamine to form a sorbent. In some embodiments, the method described herein does not include treating, contacting, or otherwise exposing the sorbent material to either of molybdenum or silver, such that the sorbent disclosed herein is substantially free of molybdenum and silver.

The additives used in such methods may be used with any of the sorbent materials described above. In particular embodiments, the additives may be at least one metal additive, such as, for example, a metal salt. The metal salt may be salts of copper (II) or copper (I). In some embodiments, the copper salt includes copper carbonate, copper chloride, copper acetate, copper gluconate, copper formate, copper sulfate, copper nitrate, or combinations thereof. In certain embodiments, the liquid portion of the impregnating solution in which the additives are dissolved or dispersed may be water. In other embodiments, the liquid portion of the impregnating solution may be an aqueous solution of water and a secondary component provided to aid dissolution of the additive into the impregnating solution. For example, in some embodiments, the impregnating solution may be a solution of metal salts or an aqueous solution containing metal salts that has been created by adding, for example, ammonia and/or ammonium carbonate, to the impregnating solution. The ammonia can aid in the dissolution of basic additives such as, for example, copper (II) carbonate (CuCO₃) or basic copper carbonate which are essentially insoluble in water. It is contemplated that ammonia may be added to an impregnating solution containing any of the copper salts described herein.

In some embodiments, the additive may include a zinc-containing compound. The zinc-containing compound may include zinc oxide, zinc hydroxide, zinc carbonate, zinc chloride, zinc acetate, zinc gluconate, zinc formate, zinc sulfate, zinc nitrate, or combinations thereof.

The methods of some embodiments may include the step of drying the sorbent material after impregnating. Drying is typically carried out after impregnating and/or between impregnating steps when the methods include more than one impregnating step. Drying can be carried out by any means, and in some embodiments, drying can be carried out in an oven, kiln, or fluid bed. In certain embodiments, the methods may include the step of moisturizing the dried activated carbon. Moisturizing can be carried out by any means including, for example, spraying water onto the adsorbent. In some embodiments, moisturizing results in an adsorbent having a moisture content up to about 25%, and in other embodiments, moisturizing may result in an adsorbent having a moisture content of about 2% to about 10%. In further embodiments, moisturizing results in an adsorbent having a moisture content of about 4% to about 8%. In some embodiments, drying the impregnated sorbent material forms a dried impregnated sorbent material.

Triethylenediamine (TEDA) may be applied by any means well known in the art, such as, for example, mixing TEDA with the dried impregnated sorbent material and then sublimation of the TEDA onto the surface of the dried impregnated sorbent material. In other embodiments, the dried impregnated sorbent material is immersed in a solution of TEDA, or a solution of TEDA is sprayed onto the surface of the dried impregnated sorbent material. In some embodiments, combinations of the above-described methods of contacting the dried impregnated sorbent material with TEDA may be employed. In some embodiments, contacting the dried impregnated sorbent material with TEDA results in TEDA being impregnated therein. In some embodiments, performing the above steps of impregnating, drying, moisturizing, applying, or other steps on a sorbent material forms a sorbent. It is contemplated that other amines, such as tetramethylethylenediamine (TMEDA), ethylenediaminetetraacetic acid (EDTA), triethylamine, di-isobutyl ethyl amine, quinuclidine, quinoxaline, ethyl triethylene diamine, 1,6-hexanediamine, pyrazine, carbazole, 1,3,5-triazine, combinations thereof, and other amines familiar to those skilled in the art may be employed in the compositions and methods of the present disclosure. Examples of suitable amines are described in U.S. Pat. No. 4,531,952, which is incorporated by reference herein in its entirety.

In some embodiments, there is provided a method of removing contaminants such as oxides of nitrogen (for example, NO and NO₂) from a fluid stream in a vehicle tunnel. The method can include providing a composition as described herein (such as a sorbent having a first surface deposition including about 1 wt. % to about 10 wt. % TEDA and about 3 wt. % to about 15 wt. % of a metal which includes copper, zinc, or a combination thereof), directing an initial fluid stream from the vehicle tunnel to an air filter device which includes the composition described herein, contacting the initial fluid stream with the composition to produce a treated fluid stream, and directing the treated fluid stream back into the vehicle tunnel. Directing the initial fluid stream from the vehicle tunnel to an air filter device and directing the treated fluid stream back into the vehicle tunnel may be conducted by any method known to those skilled in the art. In some embodiments, contacting the initial fluid stream with the composition includes passing the fluid stream over or through the composition by any means known to those skilled in the art.

In some embodiments, the treated fluid stream contains a lower concentration of nitrogen oxides such as nitrogen oxide (NO) and nitrogen dioxide (NO₂) or combinations thereof than the initial fluid stream. The concentration of nitrogen oxides such as NO and NO₂ in the initial and treated fluid streams may be measured by any method known to those skilled in the art.

Additional embodiments are directed to filters for purifying streams of fluid using the sorbents described above. Such embodiments are not limited to particular types of filters. In some embodiments, the filter may be an air filter for civilian or military applications, for example, a personal protection gas mask filter, first responder mask filter, or collective protection filter. In other embodiments, the filter may be an air filter for industrial applications such as, for example, automotive cabin air purification systems.

The filters of various embodiments may have any design and may at least include a housing, including a compartment configured to hold the sorbent and allow streams of fluid to flow over or through the sorbent. Such filters may include various additional components such as, for example, screens or other means for holding the activated carbon in the compartment or additional purification devices such as filtration membranes, particulate filters, and the like. In some embodiments, the housing may include various components necessary to allow the filter to be integrated into a device such large-scale air purifiers in which fluid stream, such as air containing vehicle exhaust, flow from one compartment to another and pass through the filter during transfer. In particular, the filter may include an inlet port for introducing streams of fluid into the filter and an outlet port for dispensing the filtered streams of fluid from the filter. In some embodiments, the filter may include a removable connecting means to connect to a gas source such as a pipe, hose, tube fittings, and the like at the inlet port.

In particular, the present disclosure describes a tunnel air filter device for removing nitrogen oxides from a vehicle tunnel. The tunnel air filter device includes, in some embodiments, the sorbent of any of the embodiments described herein. For example, the tunnel air filter device may include a sorbent having a first surface deposition including about 3 wt. % to about 15 wt. % of a metal which includes copper, zinc, or a combination thereof. In some embodiments, the vehicle tunnel is a substantially enclosed area through which vehicles travel or are stored. Vehicle tunnels may contain a fluid stream, such as air, which may include contaminants that are harmful and/or subject to regulations. For example, in some embodiments, a vehicle tunnel contains air which includes vehicle exhaust from gasoline- or diesel-powered vehicles. Such gasoline- or diesel-powered vehicles may release exhaust that contains contaminants such as nitrogen oxides (NOₓ). Particularly in a substantially enclosed environment such as a vehicle tunnel, the nitrogen oxides may accumulate to harmful levels, necessitating their removal to maintain safe air quality. The size of the vehicle tunnel is not particularly limited, though it is contemplated that vehicle tunnels may be exposed to or contain about two hundred thousand cubic meters of vehicle exhaust per hour to about ten million cubic meters of vehicle exhaust per hour. In some embodiments, the tunnel air filter device of the present disclosure is exposed to about two hundred thousand cubic meters of vehicle exhaust per hour to about ten million cubic meters of vehicle exhaust per hour. In some embodiments, the tunnel air filter device is a bypass device which is positioned inside or adjacent to a vehicle tunnel, wherein air from the vehicle tunnel is injected into the bypass device, filtered by the composition described herein, and reinjected into the vehicle tunnel or vented to the atmosphere.

The present disclosure includes the following embodiments. These embodiments may be combined in any manner to form new embodiments.
1. A composition for removing nitrogen oxides from a fluid stream in a vehicle tunnel, including:
   a sorbent having a first surface deposition comprising:
      about 1 wt. % to about 6 wt. % triethylenediamine, and
      about 3 wt. % to about 15 wt. % copper.
2. The composition of embodiment 1, wherein the sorbent includes one or more of activated carbon, natural zeolite, synthetic zeolite, silica, silica gel, alumina, zirconia, diatomaceous earths, metal organic frameworks, or combinations thereof.
3. The composition of either of embodiments 1 or 2, wherein the sorbent is in the form of pellets, granules, reagglomerated briquettes, powders, or combinations thereof.
4. The composition of any of embodiments 1-3, wherein the composition has not been treated to add molybdenum or silver.
5. The composition of any of embodiments 1-4, wherein the copper is in the form of copper (I) oxide, copper (II) oxide, elemental copper, or combinations thereof.
6. The composition of any of embodiments 1-5, wherein the first surface deposition includes about 5 wt. % to about 10 wt. % copper.
7. The composition of any of embodiments 1-6, wherein the nitrogen oxides are nitrogen dioxide, nitrogen monoxide, or combinations thereof.
8. The composition of any of embodiments 1-7, wherein the composition exhibits a longer breakthrough time than a composition which does not comprise a sorbent having a first surface deposition including about 1 wt. % to about 6 wt. % triethylenediamine and about 3 wt. % to about 15 wt. % copper.
9. The composition of any of embodiments 1-8, wherein the composition exhibits a breakthrough time of more than about 40 minutes at 25 ppm nitrogen monoxide (NO) as measured by CBRN testing method 0308 with a bed depth of 3.3 cm and a linear velocity of 12.1 cm/s.
10. The composition of any of embodiments 1-9, wherein the composition exhibits a breakthrough time of more than about 100 minutes at 25 ppm nitrogen monoxide (NO) as measured by CBRN testing method 0308 with a bed depth of 3.3 cm and a linear velocity of 12.1 cm/s.
11. A method of making a composition for removing nitrogen oxides from a fluid stream in a vehicle tunnel, including:
   contacting a sorbent material with a first solution including a copper salt to form an impregnated sorbent material,
   drying the impregnated sorbent material to form a dried impregnated sorbent material, and
   contacting the dried impregnated sorbent material with triethylenediamine to form a sorbent,
   wherein the sorbent is not impregnated with either of molybdenum or silver.
12. The method of embodiment 11, wherein the sorbent material includes activated carbon, natural zeolite, synthetic zeolite, silica, silica gel, alumina, zirconia, diatomaceous earths, or combinations thereof.
13. The method of either of embodiments 11-12, wherein the copper salt includes copper carbonate, copper chloride, copper acetate, copper gluconate, copper formate, copper sulfate, copper nitrate, or combinations thereof.
14. The method of any of embodiments 11-13, wherein the first solution further includes ammonia.
15. The method of any of embodiments 11-14, wherein contacting the dried impregnated sorbent material with triethylenediamine comprises immersing the dried impregnated sorbent material in a solution of triethylenediamine, spraying a solution of triethylenediamine onto a surface of the dried impregnated sorbent material, mixing dry triethylenediamine with the dried impregnated sorbent material, or combinations thereof.
16. The method of any of embodiments 11-15, wherein the nitrogen oxides are nitrogen dioxide, nitrogen monoxide, or combinations thereof.
17. A method of removing nitrogen oxides from a fluid stream within a vehicle tunnel, including:
   providing a composition including:
      a sorbent having a first surface deposition includes about 1 wt. % to about 6 wt. % triethylenediamine and about 3 wt. % to about 15 wt. % copper,
   directing an initial fluid stream from the vehicle tunnel to an air filter device including the composition,
   contacting the initial fluid stream with the composition to produce a treated fluid stream, and
   directing the treated fluid stream back into the vehicle tunnel.
18. The method of embodiment 17, wherein the sorbent includes activated carbon, natural and synthetic zeolite, silica, silica gel, alumina, zirconia, diatomaceous earths, metal organic frameworks, or combinations thereof.
19. The method of either of embodiments 17 or 18, wherein the sorbent is in the form of pellets, granules, reagglomerated briquettes, powders, or combinations thereof.
20. The method of any of embodiments 17-19, wherein the copper is in the form of copper (I) oxide, copper (II) oxide, elemental copper, or combinations thereof.
21. The method of any of embodiments 17-20, wherein the first surface deposition includes about 5 wt. % to about 10 wt. % copper.
22. The method of any of embodiments 17-21, wherein the nitrogen oxides are nitrogen dioxide, nitrogen monoxide, or combinations thereof.
23. The method of any of embodiments 17-22, wherein the treated fluid stream contains a lower concentration of nitrogen oxides than the initial fluid stream.
24. A tunnel air filter device for removing nitrogen oxides from a fluid stream in a vehicle tunnel, including:
   a sorbent having a first surface deposition including:
      about 1 wt. % to about 6 wt. % triethylenediamine, and
      about 3 wt. % to about 15 wt. % copper,
   wherein the sorbent is contained within a housing.
25. The tunnel air filter device of embodiment 24, wherein the tunnel air filter device is exposed to about two hundred thousand cubic meters of vehicle exhaust per hour to about ten million cubic meters of vehicle exhaust per hour.
26. The tunnel air filter device of either of embodiments 24 or 25, wherein the tunnel air filter device is positioned inside or adjacent to a vehicle tunnel.
27. The tunnel air filter device of any of embodiments 24-26, wherein the copper is in the form of copper (I) oxide, copper (II) oxide, elemental copper, or combinations thereof.
28. The tunnel air filter device of any of embodiments 24-27, wherein the first surface deposition includes about 5 wt. % to about 10 wt. % copper.
29. The tunnel air filter device of any of embodiments 24-28, wherein the nitrogen oxides are nitrogen dioxide, nitrogen monoxide, or combinations thereof.
30. The tunnel air filter device of any of embodiments 24-29, wherein the sorbent includes activated carbon, natural zeolite, synthetic zeolite, silica, silica gel, alumina, zirconia, diatomaceous earths, metal organic frameworks, or combinations thereof.
31. The tunnel air filter device of any of embodiments 24-30, wherein the sorbent is in the form of pellets, granules, reagglomerated briquettes, powders, or combinations thereof.
32. The tunnel air filter device of any of embodiments 24-31, wherein the sorbent exhibits a longer breakthrough time than a sorbent which does not have a first surface deposition including about 1 wt. % to about 6 wt. % triethylenediamine and about 3 wt. % to about 15 wt. % copper.
33. The tunnel air filter device of any of embodiments 24-32, wherein the sorbent exhibits a breakthrough time of more than about 40 minutes at 25 ppm nitrogen monoxide (NO) as measured by CBRN testing method 0308 with a bed depth of 3.3 cm and a linear velocity of 12.1 cm/s.
34. The tunnel air filter device of any of embodiments 24-33, wherein the sorbent exhibits a breakthrough time of more than about 100 minutes at 25 ppm nitrogen monoxide (NO) as measured by CBRN testing method 0308 with a bed depth of 3.3 cm and a linear velocity of 12.1 cm/s.
35. A composition for removing nitrogen oxides from a fluid stream in a vehicle tunnel, including:
   a sorbent having a first surface deposition including:
      about 1 wt. % to about 6 wt. % triethylenediamine, and
      about 3 wt. % to about 15 wt. % of a metal comprising copper, zinc, or a combination thereof.
36. The composition of embodiment 35, wherein the metal includes zinc, and the zinc is in the form of zinc oxide, elemental zinc, or combinations thereof.
37. The composition of either of embodiments 35 or 36, wherein the sorbent includes one or more of activated carbon, natural zeolite, synthetic zeolite, silica, silica gel, alumina, zirconia, diatomaceous earths, metal organic frameworks, or combinations thereof.
38. The composition of any of embodiments 35-37, wherein the sorbent is in the form of pellets, granules, reagglomerated briquettes, powders, or combinations thereof.
39. The composition of any of embodiments 35-38, wherein the composition has not been treated to add molybdenum or silver.
40. The composition of any of embodiments 35-39, wherein the copper is in the form of copper (I) oxide, copper (II) oxide, elemental copper, or combinations thereof.
41. The composition of any of embodiments 35-40, wherein the first surface deposition includes about 5 wt. % to about 10 wt. % copper.
42. The composition of any of embodiments 35-41, wherein the nitrogen oxides are nitrogen dioxide, nitrogen monoxide, or combinations thereof.
43. The composition of any of embodiments 35-42, wherein the composition exhibits a longer breakthrough time than a composition which does not comprise a sorbent having a first surface deposition including about 1 wt. % to about 6 wt. % triethylenediamine and about 3 wt. % to about 15 wt. % of a metal comprising copper, zinc, or a combination thereof.
44. The composition of any of embodiments 35-43, wherein the composition exhibits a breakthrough time of more than about 40 minutes at 25 ppm nitrogen monoxide (NO) as measured by CBRN testing method 0308 with a bed depth of 3.3 cm and a linear velocity of 12.1 cm/s.
45. The composition of any of embodiments 35-43, wherein the composition exhibits a breakthrough time of more than about 100 minutes at 25 ppm nitrogen monoxide (NO) as measured by CBRN testing method 0308 with a bed depth of 3.3 cm and a linear velocity of 12.1 cm/s.
46. A method of making a composition for removing nitrogen oxides from a fluid stream in a vehicle tunnel, including:
   contacting a sorbent material with a first solution including a copper salt, a zinc-containing compound, or a combination thereof to form an impregnated sorbent material,
   drying the impregnated sorbent material to form a dried impregnated sorbent material, and
   contacting the dried impregnated sorbent material with triethylenediamine to form a sorbent,
   wherein the sorbent is not impregnated with either of molybdenum or silver.
47. The method of embodiment 46, wherein the zinc-containing compound includes zinc oxide.
48. The method of either of embodiments 45 or 46, wherein the sorbent material includes activated carbon, natural zeolite, synthetic zeolite, silica, silica gel, alumina, zirconia, diatomaceous earths, or combinations thereof.
49. The method of any of embodiments 46-48, wherein the copper salt includes copper carbonate, copper chloride, copper acetate, copper gluconate, copper formate, copper sulfate, copper nitrate, or combinations thereof.
50. The method of any of embodiments 46-49, wherein the first solution further includes ammonia.
51. The method of any of embodiments 46-50, wherein contacting the dried impregnated sorbent material with triethylenediamine comprises immersing the dried impregnated sorbent material in a solution of triethylenediamine, spraying a solution of triethylenediamine onto a surface of the dried impregnated sorbent material, mixing dry triethylenediamine with the dried impregnated sorbent material, or combinations thereof.
52. The method of any of embodiments 46-51, wherein the nitrogen oxides are nitrogen dioxide, nitrogen monoxide, or combinations thereof.
53. A method of removing nitrogen oxides from a fluid stream within a vehicle tunnel, including:
   providing a composition including:
      a sorbent having a first surface deposition including about 1 wt. % to about 6 wt. % triethylenediamine and about 3 wt. % to about 15 wt. % of a metal comprising copper, zinc, or a combination thereof,
   directing an initial fluid stream from the vehicle tunnel to an air filter device comprising the composition,
   contacting the initial fluid stream with the composition to produce a treated fluid stream, and
   directing the treated fluid stream back into the vehicle tunnel.
54. The method of embodiment 53, wherein the sorbent includes activated carbon, natural and synthetic zeolite, silica, silica gel, alumina, zirconia, diatomaceous earths, metal organic frameworks, or combinations thereof.
55. The method of either of embodiments 53 or 54, wherein the sorbent is in the form of pellets, granules, reagglomerated briquettes, powders, or combinations thereof.
56. The method of any of embodiments 53-55, wherein the copper is in the form of copper (I) oxide, copper (II) oxide, elemental copper, or combinations thereof.
57. The method of any of embodiments 53-56, wherein the first surface deposition includes about 5 wt. % to about 10 wt. % copper.
58. The method of any of embodiments 53-57, wherein the nitrogen oxides are nitrogen dioxide, nitrogen monoxide, or combinations thereof.
59. The method of any of embodiments 53-58, wherein the treated fluid stream contains a lower concentration of nitrogen oxides than the initial fluid stream.
60. A tunnel air filter device for removing nitrogen oxides from a fluid stream in a vehicle tunnel, including:
   a sorbent having a first surface deposition including:
      about 1 wt. % to about 6 wt. % triethylenediamine, and
      about 3 wt. % to about 15 wt. % of a metal comprising copper, zinc, or a combination thereof,
   wherein the sorbent is contained within a housing.
61. The tunnel air filter device of embodiment 60, wherein the first surface deposition includes about 5 wt. % to about 10 wt. % zinc.
62. The tunnel air filter device of either of embodiments 60 or 61, wherein the tunnel air filter device is exposed to about two hundred thousand cubic meters of vehicle exhaust per hour to about ten million cubic meters of vehicle exhaust per hour.
63. The tunnel air filter device of any of embodiments 60-62, wherein the tunnel air filter device is positioned inside or adjacent to a vehicle tunnel.
64. The tunnel air filter device of any of embodiments 60-63, wherein the copper is in the form of copper (I) oxide, copper (II) oxide, elemental copper, or combinations thereof.
65. The tunnel air filter device of any of embodiments 60-64, wherein the first surface deposition includes about 5 wt. % to about 10 wt. % copper.
66. The tunnel air filter device of any of embodiments 60-65, wherein the nitrogen oxides are nitrogen dioxide, nitrogen monoxide, or combinations thereof.
67. The tunnel air filter device of any of embodiments 60-66, wherein the sorbent includes activated carbon, natural zeolite, synthetic zeolite, silica, silica gel, alumina, zirconia, diatomaceous earths, metal organic frameworks, or combinations thereof.
68. The tunnel air filter device of any of embodiments 60-67, wherein the sorbent is in the form of pellets, granules, reagglomerated briquettes, powders, or combinations thereof.
69. The tunnel air filter device of any of embodiments 60-68, wherein the sorbent exhibits a longer breakthrough time than a sorbent which does not have a first surface deposition including about 1 wt. % to about 6 wt. % triethylenediamine and about 3 wt. % to about 15 wt. % of a metal comprising copper, zinc, or a combination thereof.
70. The tunnel air filter device of any of embodiments 60-69, wherein the sorbent exhibits a breakthrough time of more than about 40 minutes at 25 ppm nitrogen monoxide (NO) as measured by CBRN testing method 0308 with a bed depth of 3.3 cm and a linear velocity of 12.1 cm/s.
71. The tunnel air filter device of any of embodiments 60-70, wherein the sorbent exhibits a breakthrough time of more than about 100 minutes at 25 ppm nitrogen monoxide (NO) as measured by CBRN testing method 0308 with a bed depth of 3.3 cm and a linear velocity of 12.1 cm/s.

### Examples

Sorbents containing copper (II) oxide and triethylenediamine were prepared according to methods of the present disclosure and the NO breakthrough time of said sorbents was evaluated. The testing conditions for breakthrough time followed Chemical, Biological, Radiological and Nuclear (CBRN) Office guidelines. The testing conditions were based on The National Institute for Occupational Safety and Health (NIOSH) Procedure No. CET-APRS-STP-CBRN-0308, with the specific conditions listed below in TABLE 1. The bed depth employed in this example was 3.3 cm, with a linear velocity of 12.1 cm/s and an empty bed contact time of 0.27 s. The challenge gas used was nitrogen dioxide, though both nitrogen dioxide and nitrogen monoxide may be present in the effluent, and one may break through before the other. In the tests described herein, the NO breakthrough time was reached first, and testing was concluded when the first breakthrough was reached. It is contemplated that the NO₂ breakthrough time may be reached first when other testing conditions are employed. The results of this testing are summarized in TABLE 2.

TABLE 1

| Challenge Gas | NO₂ at 200 ppm | |
|---|---|---|
| Breakthrough | 1 ppm NO₂/25 ppm NO | |
| Temperature/Relative Humidity | 25 C./80% | |
| Bed Depth | 3.3 | cm |
| Linear Velocity | 12.1 | cm/s |
| Empty bed contact time (EBCT) | 0.27 | s |

TABLE 2

| | | | | Apparent | Breakthrough Time |
|---|---|---|---|---|---|
| | Impregnants; | Impregnation | | Density | at 25 ppm NO |
| Example | Base Material | Procedure | PSD | (kg/m³) | (min) |
| Example 1 | 10% Cu, 5% TEDA; | Standard | 12 × 35 | 0.619 | 181.0 |
| | Coal-based activated | | | | |
| | carbon 1 | | | | |
| Example 2 | 10% Cu, 1% TEDA; | Standard | 12 × 35 | 0.590 | 147.5 |
| | Coal-based activated | | | | |
| | carbon 1 | | | | |
| Example 3 | 10% Cu, 5% TEDA; | Standard | 12 × 30 | 0.594 | 140.0 |
| | Coal-based activated | | | | |
| | carbon 2 | | | | |
| Example 4 | 10% Cu, 1% TEDA; | Standard | 12 × 30 | 0.576 | 108.5 |
| | Coal-based activated | | | | |
| | carbon 2 | | | | |
| Example 5 | 8% Zn, 5% TEDA; | Standard | 12 × 30 | 0.672 | 137.0 |
| | Coal-based activated | | | | |
| | carbon 9 | | | | |
| Example 6 | 5% Cu, 5% TEDA; | Standard | 12 × 30 | — | 135.0 |
| | Coal-based activated | | | | |
| | carbon 9 | | | | |
| Example 7 | 8% Cu, 5% TEDA; | Standard | 12 × 30 | 0.691 | 121.0 |
| | Coal-based activated | | | | |
| | carbon 9 | | | | |
| Example 8 | 5% Cu, 5% TEDA; | Standard | 12 × 30 | — | 106.7 |
| | Coconut-based | | | | |
| | activated carbon 8 | | | | |
| Example 9 | 5% Cu, 5% TEDA; | Standard | 12 × 30 | 0.549 | 98.5 |
| | Coal-based activated | | | | |
| | carbon 2 | | | | |
| Example 10 | 5% Cu, 5% TEDA; | Standard | 12 × 30 | 0.557 | 93.0 |
| | Coal-based activated | | | | |
| | carbon 2 | | | | |
| Example 11 | 5% Cu, 1% TEDA; | Standard | 12 × 30 | 0.530 | 73.5 |
| | Coal-based activated | | | | |
| | carbon 2 | | | | |
| Example 12 | 10% Zn, 5% TEDA; | Standard | 12 × 30 | 0.582 | 58.0 |
| | Coal-based activated | | | | |
| | carbon 2 | | | | |
| Comparative | K₂CO₃; | STIX | 12 × 30 | 0.609 | 35.3 |
| Example 1 | Coal-based activated | | | | |
| | carbon 2 | | | | |
| Comparative | None; | None | 12 × 40 | 0.594 | 16.9 |
| Example 2 | Coal-based activated | | | | |
| | carbon 3 | | | | |
| Comparative | None; | None | 12 × 40 | 0.617 | 15.3 |
| Example 3 | Coal-based activated | | | | |
| | carbon 4 | | | | |
| Comparative | None; | None | 12 × 40 | 0.579 | 14.9 |
| Example 4 | Coal-based activated | | | | |
| | carbon 5 | | | | |
| Comparative | 6-8% MgO; | None | 12 × 40 | 0.511 | 12.1 |
| Example 5 | Coal-based activated | | | | |
| | carbon 6 | | | | |
| Comparative | None; | None | 12 × 40 | 0.573 | 4.5 |
| Example 6 | Coal-based activated | | | | |
| | carbon 7 | | | | |
| Comparative | K₂CO₃; | STIX | 12 × 30 | 0.729 | 39.1 |
| Example 7 | Coconut-based | | | | |
| | activated carbon 8 | | | | |
| Comparative | None; | None | 12 × 30 | 0.590 | 34.1 |
| Example 8 | Coal-based activated | | | | |
| | carbon 9 | | | | |
| Comparative | 5% TEDA; | Standard | 12 × 30 | — | 30.4 |
| Example 9 | Coal-based activated | | | | |
| | carbon 9 | | | | |
| Comparative | 5% TEDA; | Standard | 12 × 30 | 0.505 | 18.4 |
| Example 10 | Coal-based activated | | | | |
| | carbon 2 | | | | |
| Comparative | None; | None | 12 × 30 | 0.487 | 16.3 |
| Example 11 | Coal-based activated | | | | |
| | carbon 2 | | | | |

As shown in TABLE 2, sorbents which included copper or zinc and TEDA, achieved a longer breakthrough time than sorbents without. Examples 1-12 which contain TEDA and zinc or copper outperform Comparative Examples 1-11, which do not contain any zinc or copper. The Examples demonstrate significantly higher breakthrough times at target concentration of 25 ppm NO than the Comparative Examples, with Examples 1-8 above 100 minutes.

By contrast, Comparative Examples 1-11, which do not contain copper or zinc, achieve a breakthrough time of at most about 35 minutes. Comparative Examples 9 and 10, which contain 5 wt. % TEDA, achieve a breakthrough time of at most 30 minutes.

Without wishing to be bound by theory, it is contemplated that the addition of copper or zinc to a sorbent material can significantly improve the NO breakthrough time, as shown in TABLE 2.

The FIGURE is a graph of nitrogen monoxide breakthrough times for a selection of sorbent materials. Similar to the data in TABLE 2, the FIGURE demonstrates that the sorbents of the present disclosure (those impregnated with copper and TEDA; Examples 1-4) exhibit longer breakthrough times than sorbents which have not undergone the treatments of the present disclosure (the FIGURE shows Comparative Examples 1 and 4-6).

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 compounds refers to groups having 1, 2, or 3 compounds. Similarly, a group having 1-5 compounds refers to groups having 1, 2, 3, 4, or 5 compounds, and so forth.

Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

What is claimed is:

1. A composition for removing nitrogen oxides from a fluid stream in a vehicle tunnel, comprising:
a sorbent having a first surface deposition comprising:
about 1 wt. % to about 6 wt. % triethylenediamine, and
about 3 wt. % to about 15 wt. % of a metal comprising copper, zinc, or a combination thereof.

2. The composition of claim 1, wherein the metal comprises zinc, and the zinc is in the form of zinc oxide, elemental zinc, or combinations thereof.

3. The composition of claim 1, wherein the sorbent comprises one or more of activated carbon, natural zeolite, synthetic zeolite, silica, silica gel, alumina, zirconia, diatomaceous earths, metal organic frameworks, or combinations thereof.

4. The composition of claim 1, wherein the sorbent is in the form of pellets, granules, reagglomerated briquettes, powders, or combinations thereof.

5. The composition of claim 1, wherein the composition has not been treated to add molybdenum or silver.

6. The composition of claim 1, wherein the copper is in the form of copper (I) oxide, copper (II) oxide, elemental copper, or combinations thereof.

7. The composition of claim 1, wherein the first surface deposition comprises about 5 wt. % to about 10 wt. % copper.

8. The composition of claim 1, wherein the nitrogen oxides are nitrogen dioxide, nitrogen monoxide, or combinations thereof.

9. The composition of claim 1, wherein the composition exhibits a longer breakthrough time than a composition which does not comprise a sorbent having a first surface deposition comprising about 1 wt. % to about 6 wt. % triethylenediamine and about 3 wt. % to about 15 wt. % of a metal comprising copper, zinc, or a combination thereof.

10. The composition of claim 1, wherein the composition exhibits a breakthrough time of more than about 40 minutes at 25 ppm nitrogen monoxide (NO) as measured by CBRN testing method 0308 with a bed depth of 3.3 cm and a linear velocity of 12.1 cm/s.

11. The composition of claim 1, wherein the composition exhibits a breakthrough time of more than about 100 minutes at 25 ppm nitrogen monoxide (NO) as measured by CBRN testing method 0308 with a bed depth of 3.3 cm and a linear velocity of 12.1 cm/s.

12. A method of making a composition for removing nitrogen oxides from a fluid stream in a vehicle tunnel, comprising:
contacting a sorbent material with a first solution comprising a copper salt, a zinc-containing compound, or a combination thereof to form an impregnated sorbent material,
drying the impregnated sorbent material to form a dried impregnated sorbent material, and
contacting the dried impregnated sorbent material with triethylenediamine to form a sorbent,
wherein the sorbent is not impregnated with either of molybdenum or silver.

13. The method of claim 12, wherein the zinc-containing compound comprises zinc oxide.

14. The method of claim 12, wherein the sorbent material comprises activated carbon, natural zeolite, synthetic zeolite, silica, silica gel, alumina, zirconia, diatomaceous earths, or combinations thereof.

15. The method of claim 12, wherein the copper salt comprises copper carbonate, copper chloride, copper acetate, copper gluconate, copper formate, copper sulfate, copper nitrate, or combinations thereof.

16. The method of claim 12, wherein the first solution further comprises ammonia.

17. The method of claim 12, wherein contacting the dried impregnated sorbent material with triethylenediamine comprises immersing the dried impregnated sorbent material in a solution of triethylenediamine, spraying a solution of triethylenediamine onto a surface of the dried impregnated sorbent material, mixing dry triethylenediamine with the dried impregnated sorbent material, or combinations thereof.

18. The method of claim 12, wherein the nitrogen oxides are nitrogen dioxide, nitrogen monoxide, or combinations thereof.

19. A method of removing nitrogen oxides from a fluid stream within a vehicle tunnel, comprising:
providing a composition comprising:
a sorbent having a first surface deposition comprising about 1 wt. % to about 6 wt. % triethylenediamine and about 3 wt. % to about 15 wt. % of a metal comprising copper, zinc, or a combination thereof,
directing an initial fluid stream from the vehicle tunnel to an air filter device comprising the composition,
contacting the initial fluid stream with the composition to produce a treated fluid stream, and
directing the treated fluid stream back into the vehicle tunnel.

20. The method of claim 19, wherein the sorbent comprises activated carbon, natural and synthetic zeolite, silica, silica gel, alumina, zirconia, diatomaceous earths, metal organic frameworks, or combinations thereof.

21. The method of claim 19, wherein the sorbent is in the form of pellets, granules, reagglomerated briquettes, powders, or combinations thereof.

22. The method of claim 19, wherein the copper is in the form of copper (I) oxide, copper (II) oxide, elemental copper, or combinations thereof.

23. The method of claim 19, wherein the first surface deposition comprises about 5 wt. % to about 10 wt. % copper.

24. The method of claim 19, wherein the nitrogen oxides are nitrogen dioxide, nitrogen monoxide, or combinations thereof.

25. The method of claim 19, wherein the treated fluid stream contains a lower concentration of nitrogen oxides than the initial fluid stream.

26. A tunnel air filter device for removing nitrogen oxides from a fluid stream in a vehicle tunnel, comprising:
a sorbent having a first surface deposition comprising:
about 1 wt. % to about 6 wt. % triethylenediamine, and
about 3 wt. % to about 15 wt. % of a metal comprising copper, zinc, or a combination thereof,
wherein the sorbent is contained within a housing.

27. The tunnel air filter device of claim 26, wherein the first surface deposition comprises about 5 wt. % to about 10 wt. % zinc.

28. The tunnel air filter device of claim 26, wherein the tunnel air filter device is exposed to about two hundred thousand cubic meters of vehicle exhaust per hour to about ten million cubic meters of vehicle exhaust per hour.

29. The tunnel air filter device of claim 26, wherein the tunnel air filter device is positioned inside or adjacent to a vehicle tunnel.

30. The tunnel air filter device of claim 26, wherein the copper is in the form of copper (I) oxide, copper (II) oxide, elemental copper, or combinations thereof.

31. The tunnel air filter device of claim 26, wherein the first surface deposition comprises about 5 wt. % to about 10 wt. % copper.

32. The tunnel air filter device of claim 26, wherein the nitrogen oxides are nitrogen dioxide, nitrogen monoxide, or combinations thereof.

33. The tunnel air filter device of claim 26, wherein the sorbent comprises activated carbon, natural zeolite, synthetic zeolite, silica, silica gel, alumina, zirconia, diatomaceous earths, metal organic frameworks, or combinations thereof.

34. The tunnel air filter device of claim 26, wherein the sorbent is in the form of pellets, granules, reagglomerated briquettes, powders, or combinations thereof.

35. The tunnel air filter device of claim 26, wherein the sorbent exhibits a longer breakthrough time than a sorbent which does not have a first surface deposition comprising about 1 wt. % to about 6 wt. % triethylenediamine and about 3 wt. % to about 15 wt. % of a metal comprising copper, zinc, or a combination thereof.

36. The tunnel air filter device of claim 26, wherein the sorbent exhibits a breakthrough time of more than about 40 minutes at 25 ppm nitrogen monoxide (NO) as measured by CBRN testing method 0308 with a bed depth of 3.3 cm and a linear velocity of 12.1 cm/s.

37. The tunnel air filter device of claim 26, wherein the sorbent exhibits a breakthrough time of more than about 100 minutes at 25 ppm nitrogen monoxide (NO) as measured by CBRN testing method 0308 with a bed depth of 3.3 cm and a linear velocity of 12.1 cm/s.
